(19) United States
(12) Patent Application Publication
(10) Pub. No.: US 2019/0208154 A1
(43) Pub. Date: Jul. 4, 2019

(54) REVERSING IMAGE DISPLAY SYSTEM WITH PACKET SELECTION MECHANISM AND METHOD THEREOF

(71) Applicant: INVENTEC BESTA CO., LTD., Taipei City (TW)

(72) Inventor: Chun-Yen TSAI, Taipei City (TW)

(21) Appl. No.: 15/857,615

(22) Filed: Dec. 29, 2017

(51) Int. Cl. H04N 5/44

(52) U.S. Cl. CPC H04N 5/4403

(57) ABSTRACT

A reversing image display system with packet selection mechanism and a method thereof are provided. A reversing image display device is interconnected with a wireless receiver which receives wireless packet wirelessly. The wireless packet corresponding to the reversing image display device is filtered out, and an authentication identifier and a control signal are parsed from the filtered wireless packet for authentication. The control signal is transmitted to the reversing image display device after the authentication identifier passes authentication. As a result, the reversing image display device can perform function according to the control signal. Therefore, the efficiency of providing wireless packet filtered by the wireless receiver which is interconnected with reversing image display device may be achieved.

### BACKGROUND

### 1. Technical Field

The present disclosure relates to a reversing image display system and a method thereof, more particularly to a reversing image display system with packet selection mechanism, and a method thereof.

### 2. Description of the Related Art

In a wireless transmission technology, a plurality of network device nodes are able to communicate with each other by long-distance transmission without through conductors or cables, so a network device node may receive wireless packets from different network device nodes.

The device, which does not have wireless transmission function in original design, is able to perform wireless transmission function after being coupled to a wireless receiver. The wireless receiver can receive wireless packets from different network device nodes, but only a part of the received packets are for the device connected with the wireless receiver; for this reason, if the wireless receiver is able to filter the packets first, the time cost for the wireless receiver processing the target packet can be reduced, and the device connected with the wireless receiver can be prevented from receiving error instruction.

Therefore, what is need is to develop a device to solve that conventional technology problem that the wireless packets are not filtered for the device coupled to the wireless receiver.

### SUMMARY

In order to solve the conventional technology problem that the wireless packets are not filtered for the device coupled to the wireless receiver, the present disclosure provides a reversing image display system with packet selection mechanism, and a method thereof.

According to an embodiment, the present disclosure provides a reversing image display system with packet selection mechanism. The reversing image display system includes a reversing image display device, a wireless receiver and a remote controller, and the wireless receiver includes a receiving module, a packet filter module, a packet parsing module, an authentication module, and a transmitting module.

The reversing image display device is disposed at the rear of vehicle, and configured to receive a control signal and perform a function corresponding to the control signal. The wireless receiver is interconnected with the reversing image display device, and the receiving module of the wireless receiver is configured to receive at least one wireless packet by a wireless transmission manner; the packet filter module of the wireless receiver is configured to filter out and select the wireless packet corresponding to the reversing image display device according to frame information of the at least one wireless packet; the packet parsing module of the wireless receiver is configured to parse packet content of the selected wireless packet to obtain an authentication identifier and the control signal; the authentication module of the wireless receiver is configured to authenticate the authentication identifier; and the transmitting module of the wireless receiver is configured to transmit the control signal to the reversing image display device when the authentication identifier of the selected wireless packet passes authentication of the authentication module. The remote controller is configured to transmit the wireless packet by wireless transmission manner.

According to an embodiment, the present disclosure provides a reversing image display method with packet filtering mechanism, and the reversing image display method includes following steps: providing a reversing image display device disposed at the rear of vehicle; providing a wireless receiver interconnected with the reversing image display device; receiving, by the wireless receiver, at least one wireless packet by wireless transmission manner; providing a remote controller which transmits the wireless packet by wireless transmission manner; filtering out and selecting, by the wireless receiver, the wireless packet corresponding to the reversing image display device according to frame information of the at least one wireless packet; parsing, by the wireless receiver, packet content of the selected wireless packet, to obtain an authentication identifier and a control signal; authenticating, by the wireless receiver, the authentication identifier; transmitting the control signal to the reversing image display device when the authentication identifier passes authentication of the wireless receiver; and performing, by the reversing image display device, a function corresponding to the control signal.

According above-mentioned content, the difference between the present disclosure and the conventional technology is that in present disclosure the reversing image display device can be interconnected with the wireless receiver, and the wireless receiver receives the wireless packet by the wireless transmission manner and filters out the wireless packet corresponding to the reversing image display device, parses the filtered wireless packet to obtain the authentication identifier and the control signal, when the authentication identifier passes the authentication of the wireless receiver, the wireless receiver transmits the control signal to the reversing image display device, so that the reversing image display device can perform the corresponding function in response to the control signal.

By using the technology of the present disclosure, the technical effect of providing the selected wireless packet to the reversing image display device coupled to the wireless receiver can be achieved.

### BRIEF DESCRIPTION OF THE DRAWINGS

The structure, operating principle and effects of the present disclosure will be described in detail by way of various embodiments which are illustrated in the accompanying drawings.

FIG. 1 is a block diagram of a reversing image display system with packet selection mechanism, in accordance with the present disclosure.

FIG. 2A and FIG. 2B are flowcharts showing the steps in an operation of a reversing image display method with packet selection mechanism, in accordance with the present disclosure.

FIG. 3 is a schematic view of architecture of the reversing image display system of the present disclosure.

### DETAILED DESCRIPTION

The following embodiments of the present invention are herein described in detail with reference to the accompanying drawings. These drawings show specific examples of the embodiments of the present invention. It is to be understood that these embodiments are exemplary implementations and are not to be construed as limiting the scope of the present invention in any way. Further modifications to the disclosed embodiments, as well as other embodiments, are also included within the scope of the appended claims. These embodiments are provided so that this disclosure is thorough and complete, and fully conveys the inventive concept to those skilled in the art. Regarding the drawings, the relative proportions and ratios of elements in the drawings may be exaggerated or diminished in size for the sake of clarity and convenience. Such arbitrary proportions are only illustrative and not limiting in any way. The same reference numbers are used in the drawings and description to refer to the same or like parts.

It is to be understood that, although the terms ‘first’, ‘second’, ‘third’, and so on, may be used herein to describe various elements, these elements should not be limited by these terms. These terms are used only for the purpose of distinguishing one component from another component. Thus, a first element discussed herein could be termed a second element without altering the description of the present invention. As used herein, the term “or” includes any and all combinations of one or more of the associated listed items.

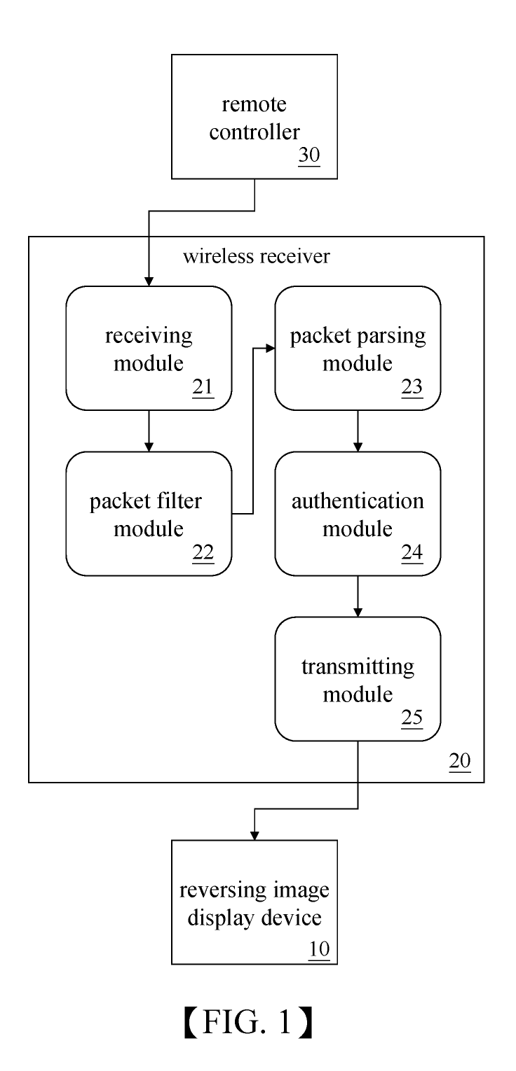

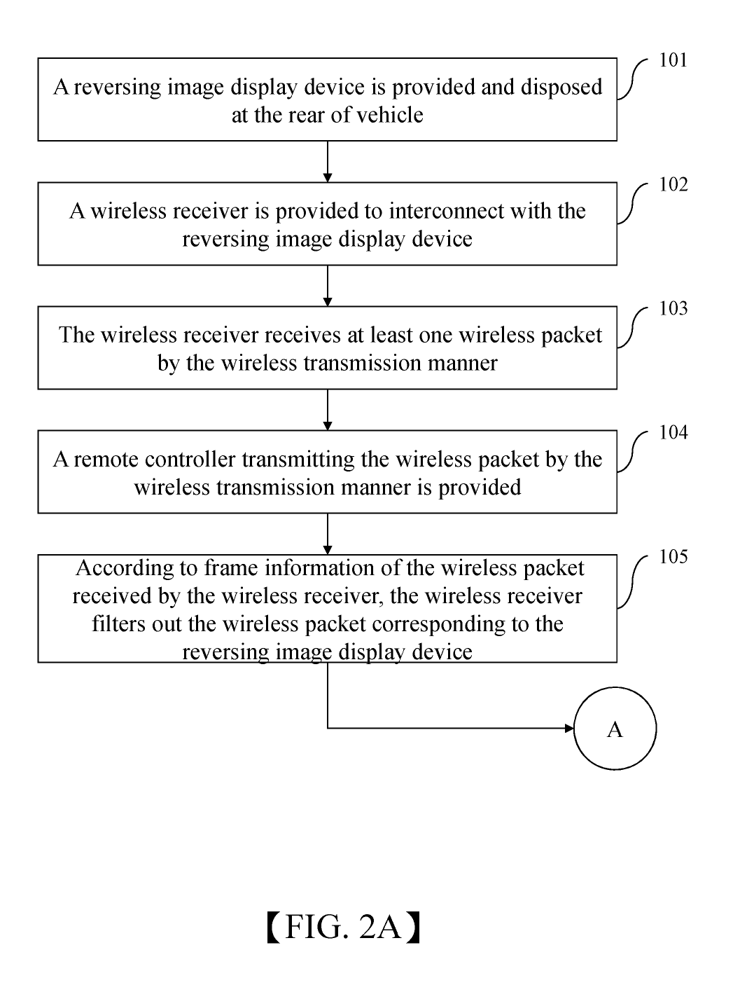

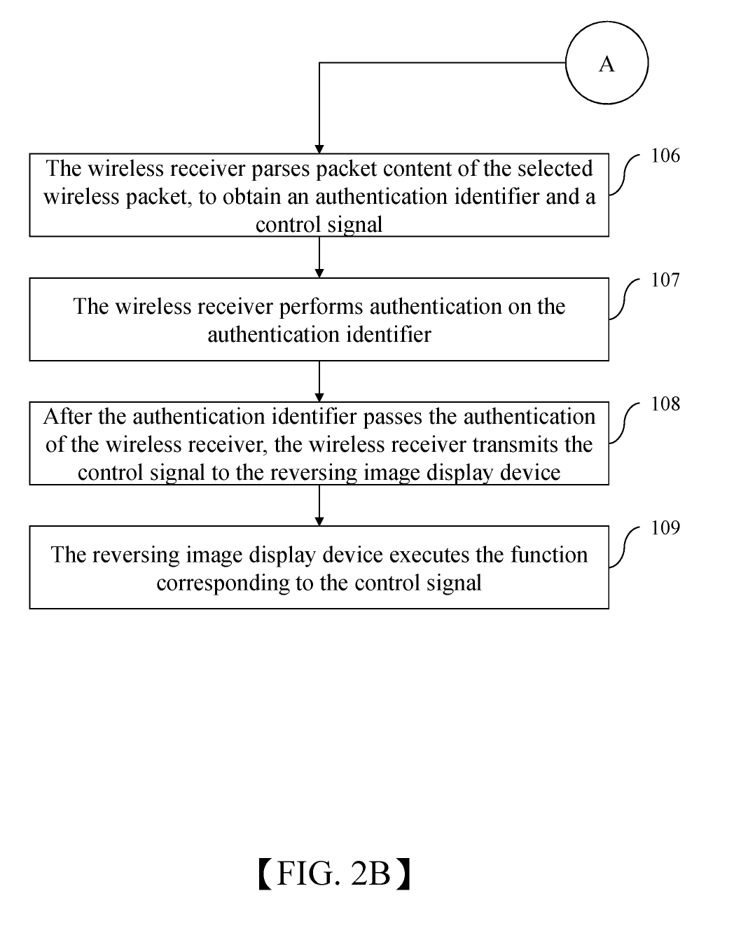

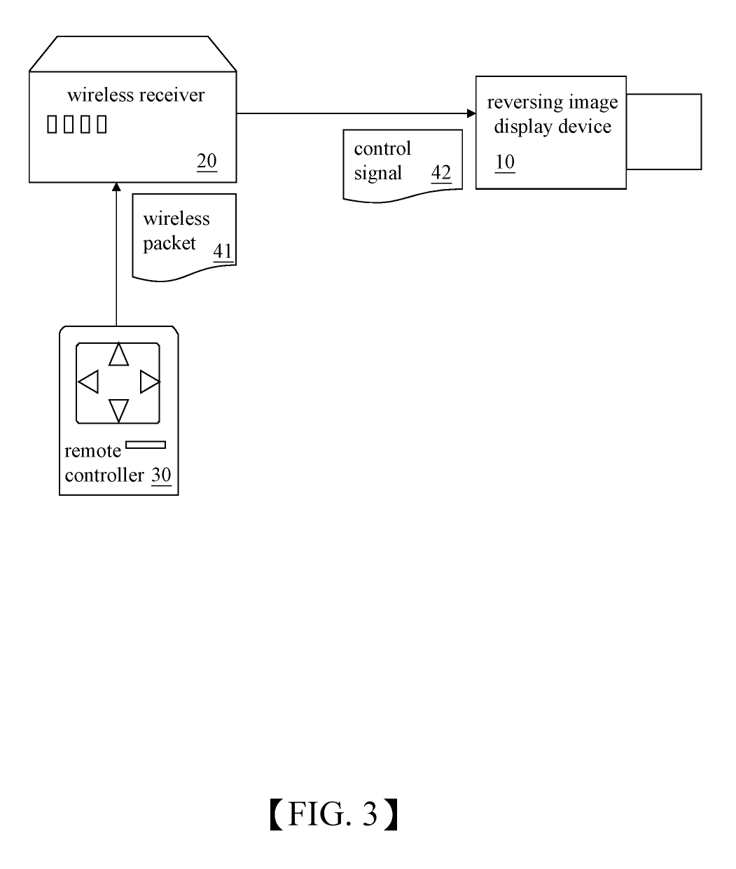

The following refers to FIGS. 1, 2A, 2B and 3 to describe operation of an embodiment for illustration the system and the method of the present disclosure. FIG. 1 is a block diagram of a reversing image display system with packet selection mechanism of the present disclosure; FIG. 2A and FIG. 2B are flowcharts showing the steps in an operation of a reversing image display method with the packet selection mechanism, in accordance with the present disclosure; and FIG. 3 is a schematic view of architecture of the reversing image display system of the present disclosure.

The reversing image display system with packet selection mechanism includes a reversing image display device 10, a wireless receiver 20 and a remote controller 30, and the wireless receiver 20 include a receiving module 21, a packet filter module 22, a packet parsing module 23, an authentication module 24 and a transmitting module 25.

In a step 101, a reversing image display device 10 is provided and disposed at the rear of vehicle, and in a step 102, the reversing image display device 10 can be interconnected with the wireless receiver 20 by a wired transmission manner or a wireless transmission manner. Preferably, the wired transmission manner may be the manner of using a transmission cable, and the wireless transmission manner may be Wi-Fi, Bluetooth, ZigBee and so on; however, these examples are merely for exemplary illustration, and the application field of the present disclosure is not limited thereto.

The remote controller 30 can be interconnected with the wireless receiver 20 by the wireless transmission manner. Preferably, the wireless transmission manner can be Wi-Fi, Bluetooth, ZigBee and so on; however, these examples are merely for exemplary illustration, and the application field of the present disclosure is not limited thereto. In an embodiment, the remote controller 30 may include an up arrow key, a down arrow key, a right arrow key, a left arrow key, a confirmation key and a mode selection key; however, these examples are merely for exemplary illustration, and the application field of the present disclosure is not limited thereto.

In a step 103, the receiving module 21 of the wireless receiver 20 receives at least one wireless packet by the wireless transmission manner; and in a step 104, the remote controller 30 transmits the wireless packet by the wireless transmission manner. The wireless packet received by the receiving module 21 of the wireless receiver 20 may be transmitted from the remote controller 30 or other device, for this reason, the wireless packet are further filtered by the packet filter module 22 of the wireless receiver 20.

In a step 105, according to frame information of the wireless packet received by the receiving module 21 of the wireless receiver 20, the packet filter module 22 of the wireless receiver 20 is able to filter out the wireless packet corresponding to the reversing image display device 10.

The wireless packets 41 are filtered by the packet filter module 22 of the wireless receiver wireless receiver 20, and the frame information of the wireless packet 41 can include a MAC field, an ID field, a Magic Byte field, a command field, a checksum field, an addressing field, and so on. The packet filter module 22 of the wireless receiver 20 can filter the wireless packets 41 to select the wireless packet corresponding to the reversing image display device 10 according to the MAC field and the addressing field of the frame information of the wireless packet 41. For example, when the MAC field and the addressing field of the frame information of the wireless packet 41 matches with the reversing image display device 10, the packet filter module 22 of the wireless receiver 20 can determine that the wireless packet 41 corresponds to the reversing image display device 10, and filter out the wireless packet 41. When the MAC field and the addressing field of the frame information of the wireless packet 41 does not match with the reversing image display device 10, the packet filter module 22 of the wireless receiver 20 determines that the wireless packet 41 does not correspond to the reversing image display device 10.

In a step 106, after the packet filter module 22 of the wireless receiver 20 filters out and select the control signal 42 corresponding to the reversing image display device 10, the packet parsing module 23 of the wireless receiver 20 parses packet content of the selected wireless packet, so as to obtain an authentication identifier and a control signal 42. The authentication identifier can be used to confirm that the filtered wireless packet is transmitted from the remote controller 30, not from other device.

In a step 107, after the packet parsing module 23 of the wireless receiver 20 parses the authentication identifier and the control signal 42, the authentication module 24 of the wireless receiver 20 performs authentication on the authentication identifier, for example, the authentication module 24 of the wireless receiver 20 can compare the authentication identifier with an identifier pre-stored in the wireless receiver 20 to check whether the authentication identifier matches with the identifier. When the authentication identifier matches with the identifier pre-stored in the wireless receiver 20, the authentication identifier passes the authentication of the authentication module 24; otherwise, when the authentication identifier does not matches with the identifier pre-stored in the wireless receiver 20, it indicates that the authentication identifier fails to pass the authentication of the authentication module 24 of the wireless receiver 20; however, these examples are merely for exemplary illustration, and the application field of the present disclosure is not limited thereto.

In a step 108, after the authentication identifier passes the authentication of the authentication module 24 of the wireless receiver 20, the transmitting module 25 of the wireless receiver 20 transmits the control signal 42 to the reversing image display device 10 by the wired transmission manner or the wireless transmission manner.

In a step 109, after the reversing image display device 10 receives the control signal 42 from the transmitting module 25 of the wireless receiver 20, the reversing image display device 10 executes the function corresponding to the control signal 42; for example, the reversing image display device 10 may perform an image process to magnify a part of the reversing image in response to the control signal 42; or, the reversing image display device 10 performs an image process to switch an image viewing angle of the reversing image. Preferably, the image process for switching the image viewing angle may include image process technology of image fisheye correction, image cropping processing, image white balance processing, image exposure processing, or a combination thereof. However, these examples are merely for exemplary illustration, and the application field of the present disclosure is not limited thereto.

The control signal 42 may include mode information and a control instruction, and the control signal 42 is generated correspondingly to a user's action of pressing the up arrow key, the down arrow key, the right arrow key, the left arrow key, the confirmation key or the mode selection key of the remote controller 30. That is, the user can press the mode selection key to select a desired mode to trigger corresponding mode information (that is, different selected modes can trigger different mode information), and the user can then press the up arrow key, the down arrow key, the right arrow key, the left arrow key or the confirmation key to trigger the different control instructions corresponding to the mode information triggered by the selected desired mode.

When the mode information indicates a normal mode, the control instruction may be an instruction for displaying parking line, an instruction for stopping displaying a parking line, an instruction for switching to display a top-view reversing image, an instruction for switching to display a horizontal-view reversing image, or an instruction for switching to display an original reversing image. The instruction for displaying parking line, the instruction for stopping displaying a parking line, the instruction for switching to display a top-view reversing image, the instruction for switching to display a horizontal-view reversing image, and the instruction for switching to display an original reversing image can respectively correspond to the up arrow key, the down arrow key, the right arrow key, the left arrow key and the confirmation key, one by one. However, these examples are merely for exemplary illustration, and the application field of the present disclosure is not limited thereto.

When the mode information indicates a setting mode, the control instruction may be an up selection instruction, a down selection instruction, a right change instruction, a left change instruction, or a confirmation instruction, and the up selection instruction, the down selection instruction, the right change instruction, the left change instruction and the confirmation instruction can respectively correspond to the up arrow key, the down arrow key, the right arrow key, the left arrow key, and the confirmation key, one by one. However, these examples are merely for exemplary illustration, and the application field of the present disclosure is not limited thereto. The up selection instruction, the down selection instruction, the right change instruction, the left change instruction and the confirmation instruction are provided to the user for adjusting a location, a distance or a width of a reversing reference line displayed on the reversing image display device 10, or for operating functional options of an user interface of the reversing image display device 10 or switching option pages of the user interface. However, these examples are merely for exemplary illustration, and the application field of the present disclosure is not limited thereto.

When the mode information indicates a remark mode, the control instruction may be a parking line selection instruction, a view area adjustment instruction, a NTSC/PAL selection instruction, a fisheye/normal view selection instruction, or an image flip/normal selection instruction. The user can operates the up arrow key, the down arrow key, the right arrow key, or the left arrow key to select the parking line selection instruction, the view area adjustment instruction, the NTSC/PAL selection instruction, the fisheye/normal view selection instruction, or the image flip/normal selection instruction, and then presses the confirmation key of the remote controller 30 to trigger the corresponding instruction. However, these examples are merely for exemplary illustration, and the application field of the present disclosure is not limited thereto.

To summarize, the difference between the present disclosure and the conventional technology is that in present disclosure the reversing image display device can be interconnected with the wireless receiver, and the wireless receiver receives the wireless packet by the wireless transmission manner and filters out the wireless packet corresponding to the reversing image display device, parses the filtered wireless packet to obtain the authentication identifier and the control signal, when the authentication identifier passes the authentication of the wireless receiver, the wireless receiver transmits the control signal to the reversing image display device, so that the reversing image display device can perform the corresponding function in response to the control signal.

By using the technology of the present disclosure, the conventional technology problem that the wireless packets are not filtered for the device coupled to the wireless receiver can be solved, and the technical effect of providing the selected wireless packet to the reversing image display device coupled to the wireless receiver can be achieved.

The present disclosure disclosed herein has been described by means of specific embodiments. However, numerous modifications, variations and enhancements can be made thereto by those skilled in the art without departing from the spirit and scope of the invention set forth in the claims.

What is claimed is:

1. A reversing image display system with packet selection mechanism, comprising:
a reversing image display device disposed at the rear of vehicle, and configured to receive a control signal and perform a function corresponding to the control signal;
a wireless receiver interconnected with the reversing image display device, and comprising:
a receiving module configured to receive at least one wireless packet by a wireless transmission manner;
a packet filter module configured to filter out and select the wireless packet corresponding to the reversing image display device according to frame information of the at least one wireless packet;
a packet parsing module configured to parse packet content of the selected wireless packet to obtain an authentication identifier and the control signal;
an authentication module configured to authenticate the authentication identifier; and
a transmitting module configured to transmit the control signal to the reversing image display device when the authentication identifier of the selected wireless packet passes authentication of the authentication module; and
a remote controller configured to wirelessly transmit the wireless packet.

2. The reversing image display system according to claim 1, wherein the reversing image display device performs an image process to magnify a part of a reversing image or switch an image viewing angle of the reversing image, according to the control signal.

3. The reversing image display system according to claim 1, wherein the control signal includes mode information and a control instruction, and when the mode information indicates a normal mode, the control instruction is an instruction for displaying parking line, an instruction for stopping displaying parking line, an instruction for switching to display top-view reversing image, an instruction for switching to display horizontal-view reversing image, or an instruction for switching to display original reversing image.

4. The reversing image display system according to claim 1, wherein the control signal includes mode information and a control instruction, and when the mode information indicates a setting mode, the control instruction is an up selection instruction, a down selection instruction, a right change instruction, a left change instruction, or a confirmation instruction.

5. The reversing image display system according to claim 1, wherein the control signal includes mode information and a control instruction, and when the mode information indicates a remark mode, the control instruction is a parking line selection instruction, a view area adjustment instruction, a NTSC/PAL selection instruction, a fish eye/normal view selection instruction, or an image flip/normal selection instruction.

6. A reversing image display method with packet filtering mechanism, comprising:
providing a reversing image display device disposed at the rear of vehicle;
providing a wireless receiver interconnected with the reversing image display device;
receiving, by the wireless receiver, at least one wireless packet by a wireless transmission manner;
providing a remote controller which wirelessly transmits the at least one wireless packet;
filtering out, by the wireless receiver, and selecting the wireless packet corresponding to the reversing image display device according to frame information of the at least one wireless packet;
parsing, by the wireless receiver, packet content of the selected wireless packet, to obtain an authentication identifier and a control signal;
authenticating, by the wireless receiver, the authentication identifier;
transmitting the control signal to the reversing image display device when the authentication identifier passes authentication of the wireless receiver; and
performing, by the reversing image display device, a function corresponding to the control signal.

7. The reversing image display method according to claim 6, wherein the step of performing the function corresponding to the control signal, further comprises:
performing, by the reversing image display device, an image process to magnify a part of a reversing image or switch an image viewing angle of the reversing image, according to the control signal.

8. The reversing image display method according to claim 6, wherein the control signal includes mode information and a control instruction, when the mode information indicates a normal mode, the control instruction is an instruction for displaying parking line, an instruction for stopping displaying parking line, an instruction for switching to display top-view reversing image, an instruction for switching to display horizontal-view reversing image, or an instruction for switching to display original reversing image.

9. The reversing image display method according to claim 6, wherein the control signal includes mode information and a control instruction, and when the mode information indicates a setting mode, the control instruction is an up selection instruction, a down selection instruction, a right change instruction, a left change instruction, or a confirmation instruction.

10. The reversing image display method according to claim 6, wherein the control signal includes mode information and a control instruction, and when the mode information indicates a remark mode, the control instruction is a parking line selection instruction, a view area adjustment instruction, a NTSC/PAL selection instruction, a fish eye/normal view selection instruction, or an image flip/normal selection instruction.
